(19) United States
(12) Patent Application Publication
(10) Pub. No.: US 2009/0144648 A1
(43) Pub. Date: Jun. 4, 2009

(54) TABBED WINDOWS FOR VIEWING MULTIMEDIA PROGRAMS

(75) Inventor: Shirin OSKOOI, San Francisco, CA (US)

Correspondence Address: HARRITY & HARRITY, LLP, 11350 Random Hills Road, SUITE 600, FAIRFAX, VA, 22030, US

(73) Assignee: GOOGLE INC., Mountain View, CA (US)

(21) Appl. No.: 11/949,929

(22) Filed: Dec. 4, 2007

(51) Int. Cl. G06F 3/048

(52) U.S. Cl. 715/777

(57) ABSTRACT

A device may, in response to a command, generate a first tabbed window that frames a viewing area on a display screen, present multimedia content in the viewing area, and expand the viewing area that contains the multimedia content to cover the display screen after presenting the multimedia content for a particular amount of time.

### BACKGROUND

A remote control may allow a user to select channels or programs for viewing, adjust display characteristics, and/or navigate a program guide. In many instances, navigating the program guide or “surfing” through a large number of television channels may be necessary for the user to find a specific type of television program for viewing.

### SUMMARY

According to one aspect, an automated method may include receiving a television program guide over a network, generating a first tabbed window on a display screen, presenting the television program guide in the first tabbed window, receiving a command selecting a television program presented in the television program guide, generating a second tabbed window in response to the command, and presenting multimedia content associated with the television program within the second tabbed window.

According to another aspect, a device may include a processor configured to receive a command for selecting a television program, generate a first tabbed window on a television in response to the command, receive the television program from a content provider; and present the television program in the first tabbed window.

According to yet another aspect, a computer-readable memory may include computer-executable instructions. The computer-executable instructions may include instructions for selecting a tabbed window in one of a plurality of groups of tabbed windows on a television screen, and overlaying the selected tabbed window on the one group of tabbed windows, receiving video streams and audio streams. In addition the computer-executable instructions may include instructions for, for each group of the groups of tabbed windows, presenting one of the video streams in a tabbed window that overlays other tabbed windows of the group, and presenting only one audio stream, the one audio stream being associated with a video stream that is being presented in the selected tabbed window.

According to still another aspect, a device may include means, responsive to a command, for generating a plurality of tabbed windows, each of the plurality of tabbed windows being associated with multimedia content. In addition, the device may include means, responsive to a command, for selecting and causing one of the plurality of tabbed windows to overlay others of the plurality of tabbed windows. The device may also include means for providing audio content with regard to only the one of the plurality of tabbed windows.

According to a further aspect, a computer-readable memory may include computer-executable instructions. The computer-executable instruction may include instructions for receiving a plurality of multimedia streams, mapping each of the plurality of multimedia streams to a movable and sizeable window, and presenting each of the windows on a television display.

According to a still further aspect, a computer-readable memory may include computer-executable instructions. The computer-executable instructions may include instructions for, in response to a command, generating a first tabbed window that frames a viewing area on a display screen. In addition, the computer-executable instructions may include instructions for presenting multimedia content in the viewing area, and expanding the viewing area that contains the multimedia content to cover the display screen after presenting the multimedia content for a particular amount of time.

### BRIEF DESCRIPTION OF THE DRAWINGS

The accompanying drawings, which are incorporated in and constitute a part of this specification, illustrate one or more embodiments described herein and, together with the description, explain the embodiments. In the drawings:

FIG. 1 is a diagram of a multimedia output device and tabbed windows;

FIG. 2 shows an exemplary system in which concepts described herein may be implemented;

FIG. 3 is a block diagram of an exemplary multimedia player device of FIG. 2;

FIG. 4 is a functional block diagram of the exemplary multimedia player device of FIG. 3;

FIG. 5 is a diagram of an exemplary tabbed window;

FIG. 6 is a diagram of a control device of FIG. 2;

FIG. 7 is a flow diagram of an exemplary process for creating and/or using tabbed windows;

FIG. 8A is a diagram of an exemplary group of tabbed windows and an exemplary multimedia output device;

FIG. 8B is a diagram of the multimedia output device of FIG. 7A after the group of FIG. 7A vanishes;

FIG. 9A is a diagram of an exemplary group of tabbed windows before a tabbed window that overlays other tabbed windows is flipped;

FIG. 9B is a diagram of the group of FIG. 8A, illustrating the tabbed window being flipped;

FIG. 10 is a diagram of exemplary multiple groups of tabbed windows;

FIG. 11A is a diagram of a user creating a group of tabbed windows; and

FIG. 11B is a diagram of the user settling in on a selected channel.

### DETAILED DESCRIPTION

The following detailed description refers to the accompanying drawings. The same reference numbers in different drawings may identify the same or similar elements.

As used herein, “multimedia content” may refer to video content and audio content associated with the video content.

### Overview

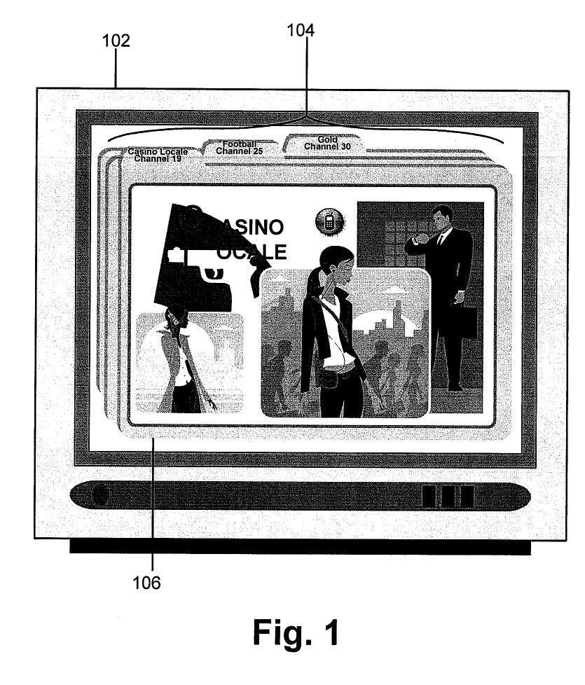

In implementations described herein, tabbed windows may be used to view multimedia content/data. FIG. 1 shows a multimedia output device 102 (e.g., a television) that displays tabbed windows 104. Each of tabbed windows 104 may be associated with multimedia content/data. Furthermore, a tabbed window 106 that overlays other tabbed windows 104 may show a video portion of multimedia content/data that is associated with tabbed window 106.

Tabbed windows 104 may be managed or controlled. For example, a user may create tabbed windows, close tabbed windows, select a tabbed window, perform preview operations on tabbed windows (e.g., continuously flip through each of tabbed windows 104), change an arrangement of tabbed windows 104, etc.

The user may use tabbed windows to focus on multimedia content/data in which the user is interested. For example, the user may create a tabbed window for a number of television programs and flip back and forth between the tabbed windows to follow the programs.

### Exemplary System

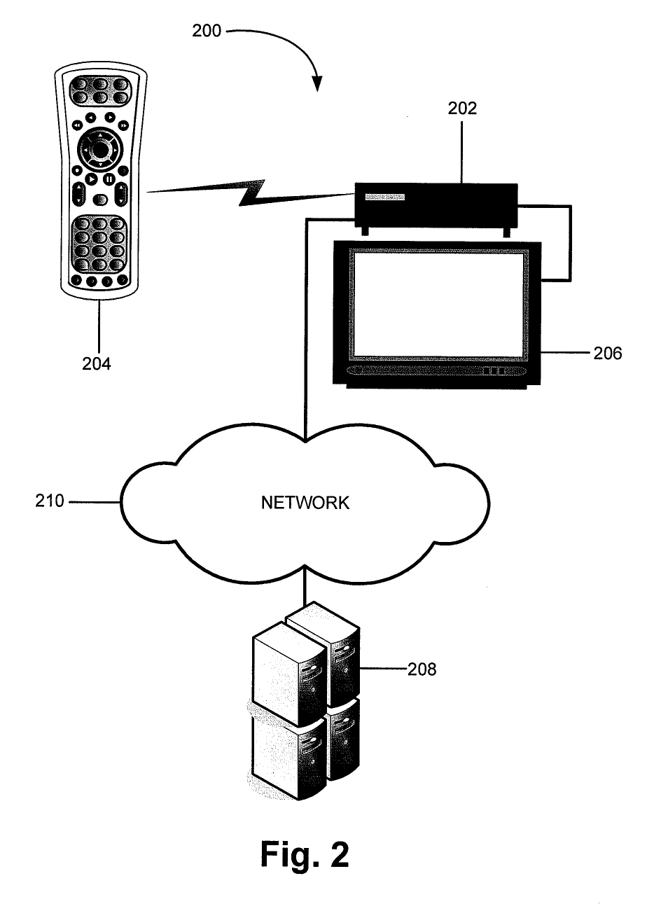

FIG. 2 shows an exemplary system 200 in which concepts described herein may be implemented. As shown, system 200 may include a multimedia player device 202, a control device 204, a multimedia output device 206, a content provider device 208, and a network 210. In different implementations, system 200 may include fewer, additional, or different devices than those illustrated in FIG. 2.

Multimedia player device 202 may include a device for receiving commands from control device 204 and for selecting and/or obtaining content that may be outputted to, presented at, or shown by multimedia output device 206 in accordance with the commands. As used herein, “multimedia player device” may refer to any media processing system that may receive multimedia content over a network and provide such multimedia content to an attached multimedia output device. Examples of multimedia player device 202 may include a set-top box or a component (e.g., a cableCARD) that plugs-into a host device (e.g., a digital video recorder, a personal computer, a television, etc.) and allows the host device to display multimedia content (e.g., contents on digital cable television channels).

In some implementations, multimedia player device 202 may receive complex viewing commands from control device 204 over a wireless communication channel (e.g., an infrared channel). While multimedia player device 202 may be implemented as different types of devices (e.g., a set-top box, a computer, a digital video disk (DVD) player, a video cassette player (VCR), a digital video recorder (DVR), a cable card, etc.), in the following paragraphs, multimedia player device 202 will be described in terms of a set-top box.

Control device 204 may include a device for issuing commands for controlling electronic devices (e.g., a stereo system, a DVD player, a set-top box, a computer, etc.). Examples of control device 204 may include a remote control, a keyboard, a mouse, a handheld device with a wireless link for remotely controlling another device, etc. In the following paragraphs, however, control device 204 will be described in terms of a remote control, as depicted in FIG. 2.

Multimedia output device 206 may include a device for outputting or presenting broadcast multimedia output device signals and/or signals from multimedia player device 202. As used herein, “multimedia output device” may refer to any device that can receive multimedia content and generate audio/visual signals based on the multimedia content (e.g., a television, a pair of speakers and a display that are attached to a computer, etc.). Examples of multimedia output device 206 may include a television, a set of speakers and a display, a portable digital assistant (PDA) or a cell phone capable of outputting a received video, etc. In the following paragraphs, however, multimedia output device 206 will be described in terms of a television.

Content provider device 208 may include one or more devices for providing content/data to multimedia player device 202 and/or multimedia output device 206. In some implementations, content provider device 208 may receive instructions from multimedia player device 202 and provide multimedia content on demand (e.g., video-on-demand). Examples of content provider device 208 may include a headend device that provides broadcast multimedia programs, a video-on-demand device that provides multimedia programs upon request, and/or a program guide server that provides information related to television programs.

Network 210 may include the Internet, an ad hoc network, a local area network (LAN), a wide area network (WAN), a metropolitan area network (MAN), a cellular network, a public switched telephone network (PSTN), any other network, or a combination of networks. Multimedia player device 202 and content provider device 208 may connect to network 210 via wireless or wired communication links.

### Exemplary Multimedia Player Device

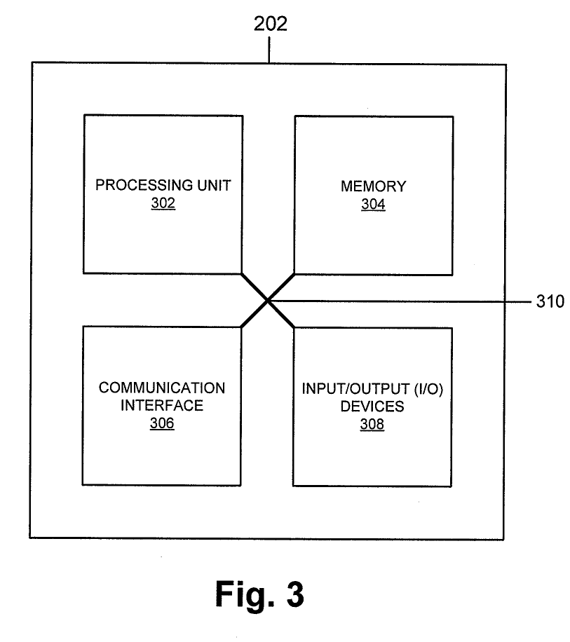

FIG. 3 is a block diagram of multimedia player device 202. As shown, multimedia player device 202 may include a processing unit 302, a memory 304, a communication interface 306, input/output devices 308, and a bus 310. Depending on implementation, multimedia player device 202 may include additional, fewer, or different components than the ones illustrated in FIG. 3. For example, multimedia player device 202 may include specialized hardware for routing data to and from network 210.

Processing unit 302 may include one or more processors, microprocessors, and/or processing logic capable of controlling multimedia player device 202. For example, processing unit 302 may include a general-purpose microprocessor and/or another type of processing device, such as field programmable gate array (FPGA), an application specific integrated circuit (ASIC) device, etc. Memory 304 may include static memory, such as read only memory (ROM), and/or dynamic memory, such as random access memory (RAM), or onboard cache, for storing data and machine-readable instructions. In some implementations, memory 304 may also include storage devices, such as a floppy disk, CD ROM, CD read/write (R/W) disk, and/or flash memory, as well as other types of storage devices.

Communication interface 306 may include any transceiver-like mechanism that enables multimedia player device 202 to communicate with other devices and/or systems. For example, communication interface 306 may include mechanisms for communicating with control device 204 via an infrared channel or devices in a network (e.g., a fiber-coaxial network, a terrestrial wireless network, a satellite-based network, a wireless LAN (WLAN), a Bluetooth-based network, a LAN, etc.). Such mechanisms may include, for example, an Ethernet interface, a WLAN interface, a Bluetooth interface, a Universal Serial Bus (USB) interface, etc. In another example, communication interface 306 may include radio frequency modulators/demodulators for receiving multimedia signals or commands.

Input/output devices 308 may include a keypad, a display panel, buttons, and/or other types of components (e.g., a video interface for selecting a video signal to be decoded or encoded, an audio interface for digitizing audio information, etc.) for converting physical events or phenomena to and/or from digital signals that pertain to multimedia player device 202.

Bus 310 may provide an interface through which the components of multimedia player device 202 can communicate with each other.

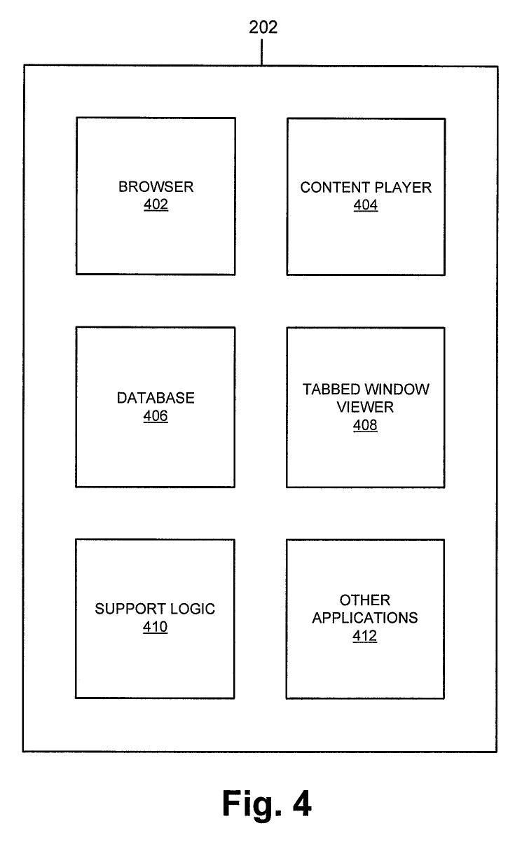

FIG. 4 is an exemplary functional block diagram of multimedia player device 202. As shown, multimedia player device 202 may include a browser 402, a content player 404, a database 406, a tabbed window viewer 408, support logic 410, and applications 412. Depending on implementation, multimedia player device 202 may include fewer, additional, or different types of components than those illustrated in FIG. 4. For example, multimedia player device 202 may include components for allowing browser 402 to be remotely controlled, device drivers, etc.

Browser 402 may include a software application that allows a user to interact with web resources (e.g., web pages, electronic documents, etc.) at websites or hosts. A user may cause, via control device 204, browser 402 to submit and receive information to and from devices in network 210. In some implementations, browser 402 may provide the ability to display layers of tabbed windows.

Content player 404 may include hardware and/or software for outputting/presenting multimedia content/data that is received from content provider device 208. Content player 404 may decode audio/video data in different formats and, based on the decoded audio/video data, may generate audio/video signals that are channeled to multimedia output device 206. Content player 404 may be implemented as a stand-alone device/application or as part of another component, such as browser 402.

Database 406 may act as an information repository for other components of multimedia player device 202. In one implementation, database 406 may store records related to tabbed windows. For example, the records may store user preferences related to tabbed windows (e.g., the location of a tab relative to a window, a duration of time for which a tab may remain visible on a display screen when a user does not interact with multimedia player device 202, the total number of tabs that may be created on the display screen, an arrangement of tabs on the display screen, etc.). In another example, the records may store information that associates a channel and/or specific multimedia content with a tabbed window. In yet another example, the records may also include information about groups of tabbed windows. The term “group” of tabbed windows, or “tabbed group,” as used herein, may refer to a collection of tabbed windows (e.g., a set of tabbed windows that are associated with movies).

Tabbed window viewer 408 may include hardware and/or software for managing tabbed windows. More specifically, tabbed window viewer 408 may provide supporting mechanisms for accepting and responding to tabbed window-related commands that are issued from control device 204. In response to the commands (e.g., a generate tabbed window command, a select tabbed window command, etc.) tabbed window viewer 408 may create a tabbed window, select a tabbed window, create a group of tabbed windows, size a tabbed window, resize a tabbed window, move a tabbed window, and/or close a tabbed window.

In addition, tabbed window viewer 408 may use content player 404 to generate multimedia signals and send the generated signals to multimedia output device 206. In one implementation, given a tabbed group, tabbed window viewer 408 may send multimedia signals for only one tabbed window in the group. For example, in FIG. 1, assuming that tabbed windows 104 are part of a tabbed group, only multimedia signals associated with a tabbed window that overlays other tabbed windows may be channeled from multimedia player device 202 to multimedia output device 206. In one alternative implementation, tabbed window viewer 408 may present/output video and/or audio associated with multimedia content for more than one tabbed window.

In some implementations, tabbed window viewer 408 may be capable of storing information about tabbed windows/groups in database 406. The stored information may later be retrieved by tabbed window viewer 408 to recreate the tabbed windows. In other implementations, tabbed window viewer 408 may provide a graphical user interface (GUI) menu system for managing the tabbed windows/groups. For example, a user might be permitted to interact with GUI to select a group of tabbed windows among many groups of windows that are stored in database 406.

Support logic 410 may provide a support for various components in multimedia player device 202. For example, support logic 410 may provide a Transmission Control Protocol (TCP)/Internet Protocol (IP) stack, buffers for received data, etc. In addition, support logic 410 may provide a support for interfacing browser 402, content player 404, tabbed window viewer 408, and/or applications 412 to hardware components, such as microphone, display, etc.

Applications 412 may include hardware and/or software for providing various functionalities of multimedia device 202, such as email, Multimedia Messaging, wireless (e.g., Bluetooth) communications, infrared communications, web access, file uploading and downloading, image transfer, etc.

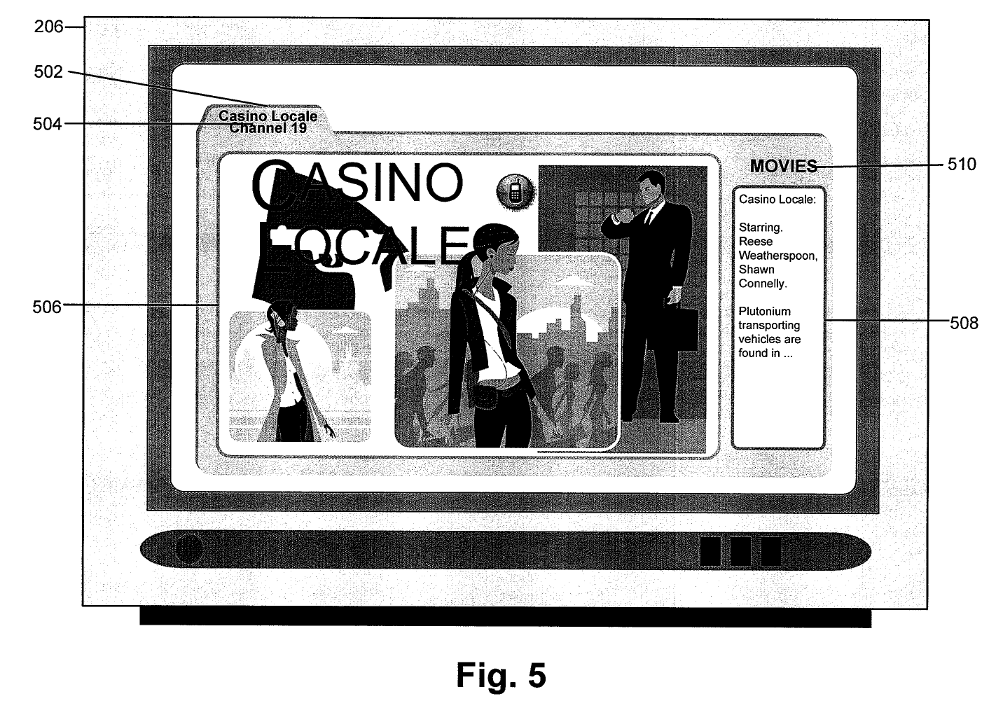

FIG. 5 depicts an exemplary tabbed window 502 that may be created by tabbed window viewer 408 and displayed on multimedia output device 206. As shown, tabbed window 502 may include a tab 504 and a viewing pane 506, an information pane 508, and a group name 510. In different implementations, tabbed window 502 may include fewer, additional, or different components than those shown in FIG. 5.

Tab 504 may display information (e.g., an icon, text, etc.) related to multimedia content that is currently being presented in viewing pane 506. Examples of the information may include: the name of the multimedia content; the number of the channel on which the multimedia content is delivered; a time interval during which the multimedia content may be conveyed from content provider device 208 to multimedia player device 202; etc. In different implementations, tab 504 may be shown near the top, bottom or sides of multimedia output device 206. In one implementation, the location of tab 504 may be adjustable (e.g., user configurable).

Viewing pane 506 may present a video portion of multimedia content/data. Information pane 508 may display information (e.g., a description, an image, a short video clip, etc.) about multimedia content that is being presented in viewing pane 506. Group name 510 may display the name or an icon of a group of tabbed windows to which tabbed window 502 may belong. A tabbed window may or may not belong to a tabbed group.

### Exemplary Control Device

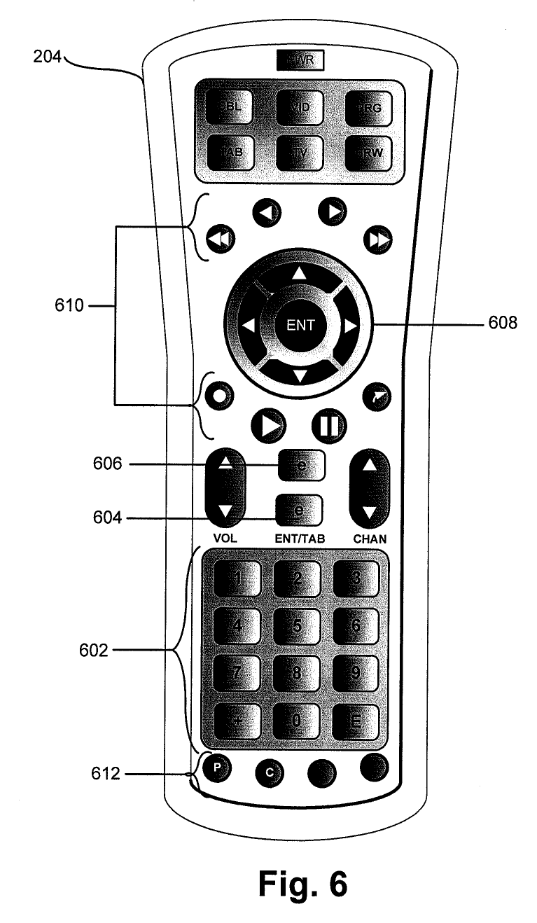

FIG. 6 is an expanded diagram of control device 204 that may issue commands to multimedia player device 202. As shown, control device 204 may include a numeric keypad 604, an enter/tab button 604, a program guide button 606, arrow buttons 608, play buttons 610, and other buttons 612. Pressing on some of these buttons may cause control device 204 to issue a command (e.g., a generate tabbed window command, a close tabbed window command, etc.) to multimedia player device 202 and cause multimedia player device 202 to perform a specific function. Depending on implementation, control device 204 may include fewer, additional, or different components.

Numeric keypad 602 may be used to enter a number (e.g., a channel number) or other types of data at multimedia player device 202. Enter/tab button 604 may be used to issue a channel change command, a generate tabbed window command, etc. Enter/tab button 604 may cause multimedia player device 202 to accept a channel number that has been entered via numeric keypad 602, create a tabbed window, and associate the tabbed window with a channel. Depending on implementation, pressing on enter/tab button 604 may provide additional functionalities, such selecting a group to which a tabbed window belongs. Pressing on program guide button 606 may cause a command to be issued for presenting a program guide in a tabbed window. Depending on implementation, a program item in the program guide may be selected by using enter/tab button 604. Using the enter/tab button 604 may cause a generate tabbed window command to be issued to multimedia player device 202, to create a new tabbed window for playing multimedia content associated with the item.

Arrow buttons 608 may permit a user to activate a tabbed window. For example, assume that the user manages a group of tabbed windows. FIG. 1 shows the group of tabbed windows 104 that may be displayed at multimedia output device 206. Using arrow buttons 608, the user may cause one of tabs of group to be selected. When the user has selected a tabbed window that the user wishes to view, the user may press the enter button of arrow buttons 608 and activate the tabbed window. When activated, the tabbed window may overlay other tabbed windows 104 and play multimedia content of the channel that has been associated with the tabbed window.

In some implementations, arrow buttons 608 may be used in conjunction with enter/tab button 604. For example, assume that the user is browsing through a program menu. The user may move to a program on the menu by using arrow buttons 608. When the user presses on enter/tab button 604, a new tabbed window for the selected program may be created underneath the menu, so that the user can continue to browse for shows. Alternatively, if the user presses on the enter button of arrow buttons 608, the new tabbed window may be created over other tabbed windows, permitting the user to view the selected program. In one implementation, arrow buttons 608 may be used to size, resize, and/or move a window.

Play buttons 610 may be used to control playing multimedia contents at multimedia player device 202 (e.g., fast forward, rewind, etc.). In some implementations, if a tabbed group is activated, play buttons 610 may cause multimedia player device 202 to perform a preview operation. For instance, if a group of tabbed windows 104 as illustrated in FIG. 1 is selected and the user presses one of play buttons 610, a tabbed window may remain visible as it overlays the group of tabbed windows 104 for a predetermined amount of time. After the time elapses, the tabbed window may be automatically placed at the bottom of group of tabbed windows 104. The preceding process may be repeated, to continuously flip through the tabbed windows. Other buttons in play buttons may cause other functions related to the slide show, such as stopping the slide show, speeding up the rate of flipping, etc.

Other buttons 612 may include components for issuing commands that are commonly provided by control devices. In some implementations, when tabbed windows are being controlled, commands from some of other buttons 612 may cause multimedia player device 202 to perform operations related to tabbed windows. For example, a command from other buttons 612 may close, may move, may size, or may resize an activated tabbed window or a selected group. In another example, other buttons 612 may permit a user to reactivate windows/groups that have been created by the user, but are not currently displayed on multimedia output device 206.

### Exemplary Processes for Creating and/or Using Tabbed Windows

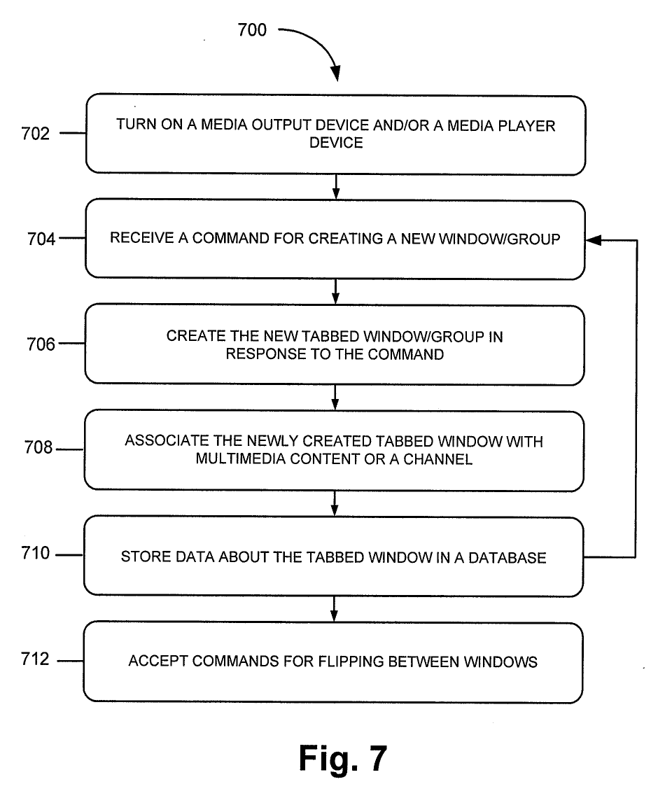

The above paragraphs describe system elements that are related to devices and/or components for creating and/or viewing tabbed windows. FIG. 7 shows an exemplary process 700 that is capable of being performed by one or more of these devices and/or components or by a content provider (e.g., a cable television company).

As shown, process 700 may include blocks that represent acts for creating and/or using tabbed windows. Process 700 may begin at block 702, where multimedia output device 206 and/or multimedia player device 202 may be turned on.

A command for creating a new tabbed window may be received by multimedia player device 202 (block 704). The command may be issued from control device 202 in various ways. For example, the user may enter a channel number or select a program on a program guide. The entry of the channel number or the selection of the program may be interpreted by tabbed window viewer 408 as a command to create a tabbed window that shows the channel or the program. In a different implementation, the user may enter a channel number and press an enter button or a dedicated “tab” button on control device 204, to indicate that the user wishes to view the channel. In yet another implementation, the user may press a channel up/down button to create a tabbed window.

A new tabbed window may be created in response to the command (block 706). In many implementations, a user may be able to control whether the new tabbed window is created so that the new tabbed window overlays another tabbed window or underlays another tabbed window.

In some implementations, if the user does not perform an additional operation on a tabbed window that has been displayed for a particular amount of time (e.g., 5 seconds), the tabbed window may automatically vanish. For example, if the tabbed window has been displayed for the particular amount of time without an additional operation by the user, multimedia output device 206 may expand the video portion of the multimedia content associated with the tabbed window to cover the entire display screen.

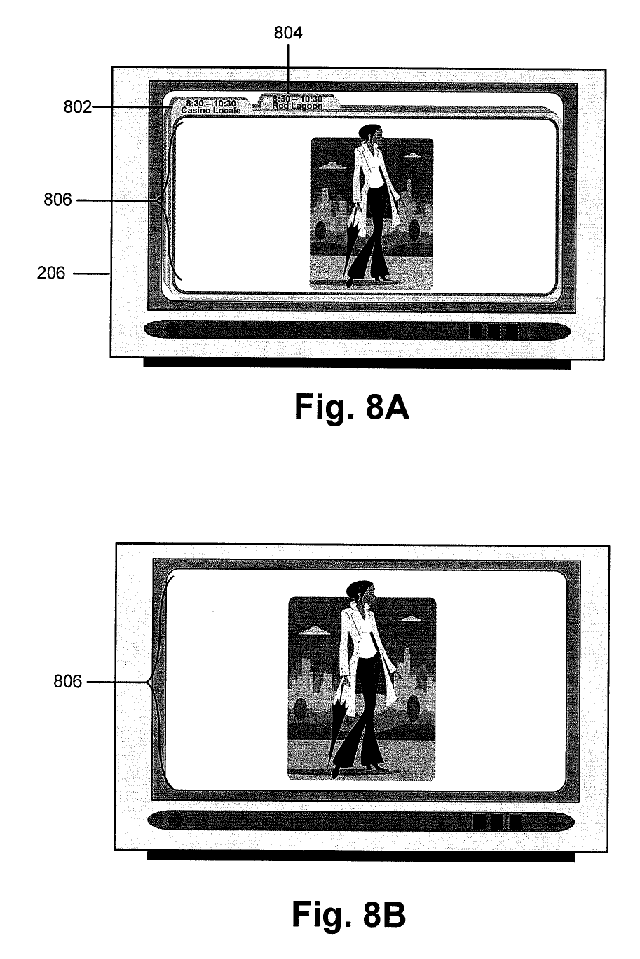

FIGS. 8A and 8B illustrate the feature. As shown in FIG. 8A, tabbed windows 802 and 804 may be displayed on multimedia output device 206. Assume that a user has created tabbed window 804 beneath tabbed window 902. If the user does not perform any activities related to tabbed windows 802/804, tabbed windows 802/804 may be automatically removed. FIG. 8B shows the result of removing tabbed windows 802/804, leaving video portion 806 on multimedia output device 206 to be viewed without clutter. Removing tabbed windows 802/804 may result in video portion 806 being rescaled to fit the display screen of multimedia output device 206.

Returning to FIG. 7, the newly created tabbed window may be automatically associated with multimedia content or a channel (block 708). For example, if the user creates a tabbed window by pressing on “4” of a numeric keypad on control device 204, channel 4 may be associated with the tabbed window.

Data about the new tabbed window may be stored in database 406 (block 710). The data may include, for example, the channel number, the name of the multimedia content associated with the tabbed window, etc. If the user attempts to restore a tabbed window or a group of tabbed windows that the user has created, the stored data may be retrieved from database 406 and used to recreate the window or the group of tabbed windows.

At block 710, if all desired tabbed windows have not been created, process 700 may proceed to 702 to create additional tabbed windows. Otherwise, process 700 may proceed to block 712.

At block 712, a tabbed window may be selected. By using arrow buttons on control device 204, the user may select one tabbed window after another, to preview multimedia contents. In some implementations, tabbed window viewer 408 may provide a facility for automating a preview. If the user starts the automated preview, via control device 204, each of the tabbed windows in a group may display its viewing pane as it overlays the group for a predetermined amount of time. After the time elapses, the tabbed window may subsequently move behind the bottom layer position of the group. The process may be repeated, to continuously flip through the tabbed windows. If the user no longer wishes to view a particular tabbed window in the group, the user may close the tabbed window using one of the buttons on control device 204.

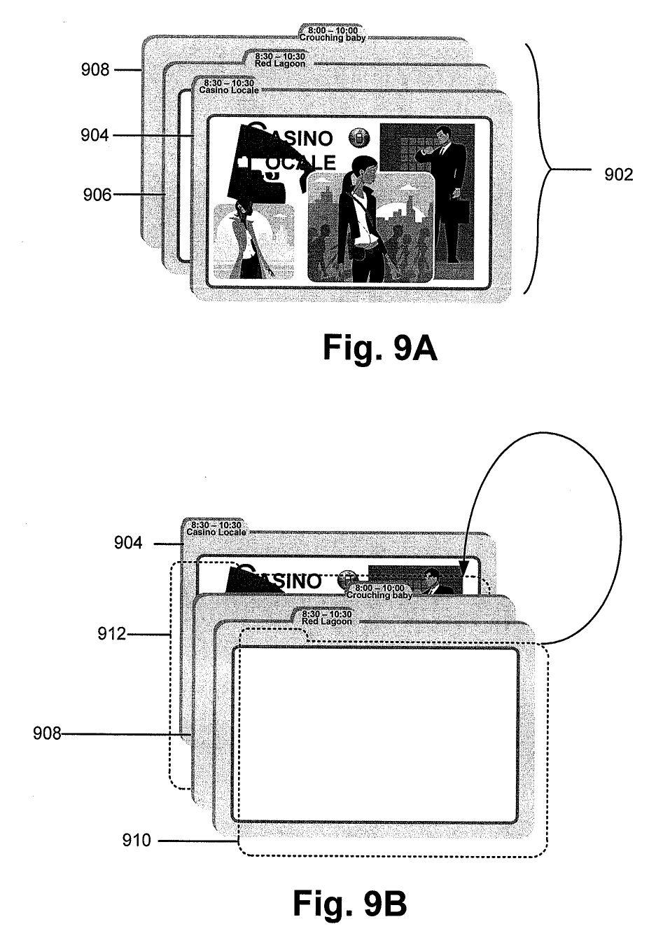

FIGS. 9A and 9B illustrate the automated preview process. As shown in FIG. 9A, a group 902 may include tabbed windows 904, 906, and 908. Further, as shown in FIG. 9B, during the automated preview process, tabbed window 904 may be moved from a top layer position 910 in which tabbed window 904 overlays other tabbed windows to a bottom layer position 912 in which tabbed window 904 underlays other tabbed windows.

The user may continue to preview tabbed windows decide to watch a channel. When the user settles in on a channel, process 700 may terminate. The user may “settle in” on the channel by selecting a tabbed window associated with the channel and waiting for or causing the tabbed windows to disappear (e.g., press on a button on control device 204).

### Alternative Implementations

Many changes to the components and the process for creating and/or using tabbed windows may be implemented. For example, in one implementation, tabbed window viewer 408 may support “jump” functionality in control device 204, so that a user may jump between a large number of channels.

In another implementation, tabbed window 408 may allow a user to create and/or store multiple groups of tabbed windows via control device 204. In such implementation, each group of tabbed windows may correspond to a set of multimedia contents. The user may retrieve a group of windows which the user is interested in previewing or flipping, rather than browsing through a program guide that may list hundreds of channels.

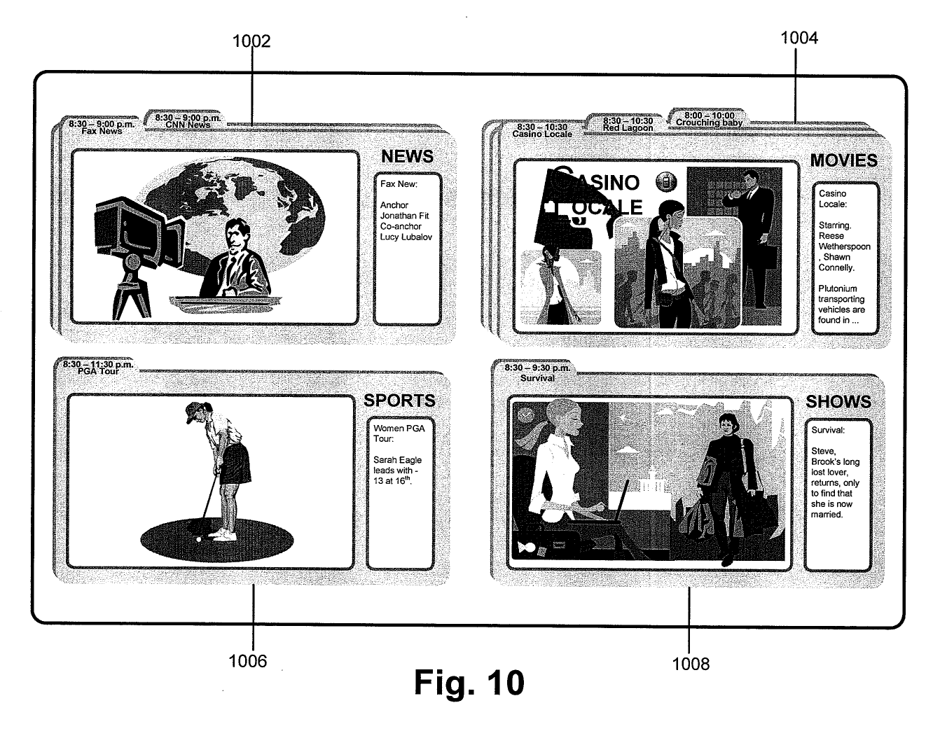

FIG. 10 is a diagram of exemplary multiple groups of tabbed windows. As shown, each of groups 1002-1008 may include a tabbed window that shows/displays multimedia content. By using control device 204, the user may position previously created tabbed windows/groups on the screen of multimedia output device 206.

### EXAMPLES

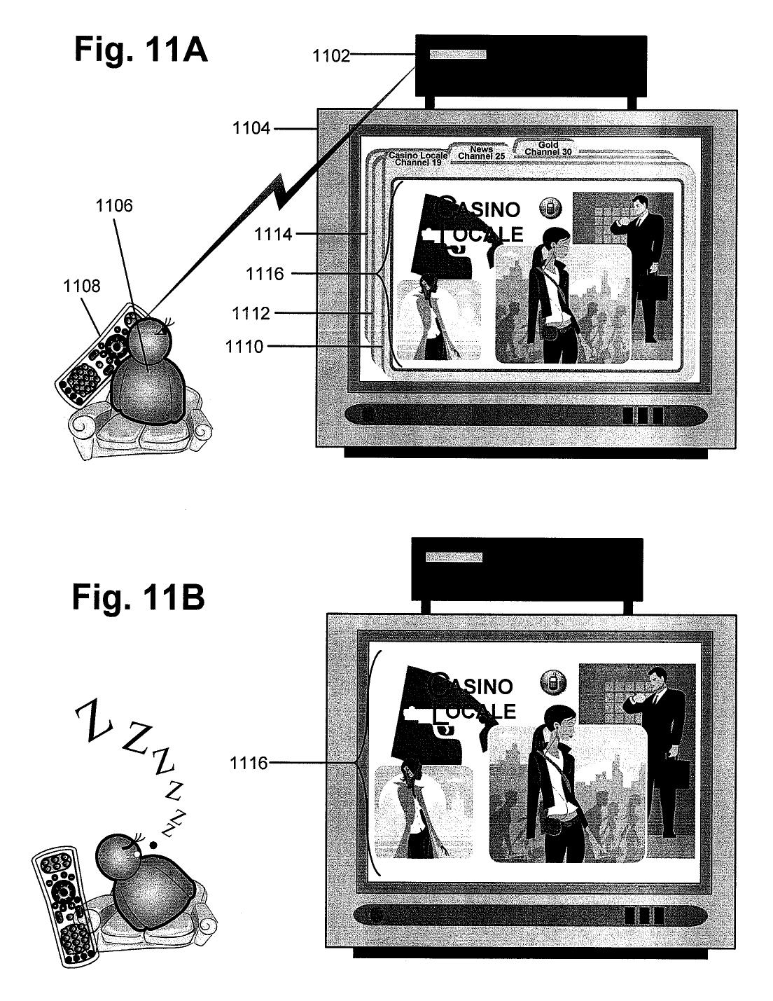

The following examples illustrate the process for creating and/or viewing tabbed windows, with reference to FIGS. 11A, 11B, and 11C. The example is also consistent with the exemplary process described above with reference to FIG. 7.

In FIG. 11A, assume that a set-top box 1102 is attached to a television 1104 and that Shirin 1106, a user, uses a remote control 1108 to control set-top box 1102. In addition, assume that Shirin 1106 wishes to flip through a group of tabbed windows that show movies, shows, news, etc.

By using remote control 1108, Shirin 1106 creates a group of tabbed windows 1110, 1112, and 1114 that are associated with her favorite channels 19, 25, and 30. By using remote control 1102, Shirin jumps between channels 19, 25, and 30 continuously, as she is interested in tracking all television programs that are being presented on channels 19, 25 and 30.

After a few minutes, Shirin tires of channel flipping and decides to finish watching Casino Locale 1116 which is shown on channel 19. Shirin causes tabbed window 1110 to remain overlaid on other tabbed windows 1112 and 1114 and continues to watch. As shown in FIG. 11B, after a few seconds, tabbed windows 1110-1114 vanish, allowing Shirin to watch Casino Locale 1116 unobstructed.

### Conclusion

The foregoing description of implementations provides illustration, but is not intended to be exhaustive or to limit the implementations to the precise form disclosed. Modifications and variations are possible in light of the above teachings or may be acquired from practice of the teachings.

For example, in one implementation, instead of inputting commands via various buttons on control device 204, multimedia player device 202 may provide for a menu system. Many of the commands for managing and/or controlling the tabbed windows/groups may be triggered by navigating through the menu system and activating a menu item.

In another example, while series of blocks have been described with regard to process 700 illustrated in FIG. 7, the order of the blocks may be modified in other implementations. In addition, non-dependent blocks may represent acts that can be performed in parallel to other blocks.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, an application specific integrated circuit, or a field programmable gate array, software, or a combination of hardware and software.

Even though particular combinations of features are recited below in the claims, these combinations are not intended to be limiting the implementations. In fact, many of these features may be combined in ways not specifically recited in the claims.

No element, act, or instruction used in the present application should be construed as critical or essential to the implementations described herein unless explicitly described as such. Also, as used herein, the article “a” is intended to include one or more items. Where one item is intended, the term “one” or similar language is used. Further, the phrase “based on” is intended to mean “based, at least in part, on” unless explicitly stated otherwise.

What is claimed is:

1. An automated method comprising:
receiving a television program guide over a network;
generating a first tabbed window on a display screen;
presenting the television program guide in the first tabbed window;
receiving a command selecting a television program presented in the television program guide;
generating a second tabbed window in response to the command; and
presenting multimedia content associated with the television program within the second tabbed window.

2. The method of claim 1, further comprising:
closing the second tabbed window in response to a command.

3. The method of claim 1, further comprising:
presenting information about the multimedia content in a tab that is part of the second tabbed window.

4. The method of claim 1, further comprising:
generating a third tabbed window in response to a command; and
presenting the third tabbed window so that the third tabbed window overlays the second tabbed window.

5. The method of claim 4, where presenting the third tabbed window includes:
causing the third tabbed window to overlay the second tabbed window for a particular amount of time; and
subsequently and automatically causing the second tabbed window to overlay the third tabbed window after expiration of the particular amount of time.

6. A device, comprising:
a processor configured to:
receive a command for selecting a television program;
generate a first tabbed window on a television in response to the command;
receive the television program from a content provider; and
present the television program in the first tabbed window.

7. The device of claim 6, where the processor is further configured to:
expand the first tabbed window to cover an entire viewable area of a display screen of the television.

8. The device of claim 7, where the processor is further configured to:
change a location of the first tabbed window on the television.

9. The device of claim 6, where the processor is further configured to:
in response to a command, generate a second tabbed window associated with another television program.

10. The device of claim 9, where the second tabbed window overlays the first tabbed window when the second tabbed window is generated.

11. The device of claim 9, where the second tabbed window underlays the first tabbed window when the second tabbed window is generated.

12. The device of claim 9, where the processor is further configured to:
provide an audio signal associated with the television program for the first tabbed window only when the first tabbed window overlays the second tabbed window.

13. The device of claim 6, where the first tabbed window includes:
a tab that displays information about the television program.

14. The device of claim 13, where the information includes at least one of:
a name of the television program;
a time at which the television program is being broadcast; or
an identifier for the channel on which the television program is being broadcast.

15. The device of claim 6, where the processor is further configured to:
store configurable parameters that are associated with generating, presenting, or removing the first tabbed window.

16. A computer-readable memory that includes computer-executable instructions, the computer-executable instructions comprising instructions for:
selecting a tabbed window in one of a plurality of groups of tabbed windows on a television screen;
overlaying the selected tabbed window on the one group of tabbed windows;
receiving video streams and audio streams;
for each group of the groups of tabbed windows, presenting one of the video streams in a tabbed window that overlays other tabbed windows of the group; and
presenting only one audio stream, the one audio stream being associated with a video stream that is being presented in the selected tabbed window.

17. The computer-readable memory of claim 16, wherein said selecting is in response to a command.

18. A device comprising:
means responsive to a command for generating a plurality of tabbed windows, each of the plurality of tabbed windows being associated with multimedia content;
means responsive to a command for selecting and causing one of the plurality of tabbed windows to overlay others of the plurality of tabbed windows; and
means for providing audio content with regard to only the one of the plurality of tabbed windows.

19. The device of claim 18, comprising:
means for automatically causing each of the tabbed windows to overlay all of the other tabbed windows for a particular amount of time.

20. A computer-readable memory that includes computer-executable instructions, the computer-executable instruction comprising instructions for:
receiving a plurality of multimedia streams;
mapping each of the plurality of multimedia streams to a movable and sizeable window; and
presenting each of the windows on a television display.

21. The computer-readable memory of claim 20, further comprising instructions for:
in response to a command, causing at least one of said windows to underlay another one of said windows.

22. The computer-readable memory of claim 20, further comprising instructions for:
in response to a command, causing at least one of said windows to overlay another one of said windows.

23. The computer-readable memory of claim 20, further comprising instructions for:
receiving a command for selecting a channel; and
generating a new moveable and sizeable window in response to the command for selecting a channel.

24. The computer-readable memory of claim 20, further comprising instructions for:
automatically causing one of the windows to expand to cover an entire viewable area of the television display.

25. The computer-readable memory of claim 20, further comprising instructions for:
automatically causing one or more of the windows to close.

26. The computer-readable memory of claim 20, further comprising instructions for:
presenting at least two of said windows so that an entire viewable area of each window is displayed simultaneously.

27. The computer-readable memory of claim 20, further comprising instructions for:
in response to a command, moving at least one of said windows on the television display.

28. The computer-readable memory of claim 20, further comprising instructions for:
in response to a command, changing the size of at least one of said windows on the television display.

29. A computer-readable memory that includes computer-executable instructions, the computer-executable instructions comprising instructions for:
in response to a command, generating a first tabbed window that frames a viewing area on a display screen;
presenting multimedia content in the viewing area; and
expanding the viewing area that contains the multimedia content to cover the display screen after presenting the multimedia content for a particular amount of time.

30. The computer-readable memory of claim 29, further comprising instructions for:
in response to a command, generating a second tabbed window that underlays the first tabbed window.

31. The computer-readable memory of claim 30, further comprising instructions for:
in response to a command, moving the second tabbed window to overlay the first tabbed window.

32. The computer-readable memory of claim 29, where the instructions for generating the first tabbed window include instructions for:
receiving a command for changing a channel; and
generating the first tabbed window in response to the command for changing a channel.

33. The computer-readable memory of claim 29, where the instructions for generating the first tabbed window include instructions for:
receiving a command for selecting a channel; and
generating the first tabbed window in response to the command for selecting a channel.

34. The computer-readable memory of claim 29, further comprising instructions for:
presenting a program guide in the first tabbed window;
receiving a command selecting a television program presented in the program guide;
generating a second tabbed window in response to the command for selecting the television program; and
presenting multimedia content associated with the television program within the second tabbed window.

35. The computer-readable memory of claim 34, where the instructions for generating the second tabbed window include instructions for:
presenting the second tabbed window so that the second tabbed window underlays the first tabbed window in response to the command selecting the television program.
